(19) United States
(12) Patent Application Publication
(10) Pub. No.: US 2026/0237034 A1
(43) Pub. Date: Aug. 13, 2026

(54) COMMUNICATION LAMP FOR VEHICLE AND METHOD FOR CONTROLLING THE SAME

(71) Applicant: HYUNDAI MOBIS CO., LTD., Seoul (KR)

(72) Inventor: Myeong Je KIM, Yongin-si (KR)

(73) Assignee: HYUNDAI MOBIS CO., LTD., Seoul (KR)

(21) Appl. No.: 19/358,969

(22) Filed: Oct. 15, 2025

(30) Foreign Application Priority Data
Feb. 7, 2025 (KR) 10-2025-0015929

(51) Int. Cl. G06T 5/80; G06T 3/18; G06T 7/00

(52) U.S. Cl. CPC G06T 5/80; G06T 3/18; G06T 7/0002; G06T 2207/30252

(57) ABSTRACT

Disclosed is a communication lamp for a vehicle. The communication lamp includes a vehicle interface that receives content data from the vehicle, a controller that analyzes the content data to generate brightness data for each pixel, a memory that stores the brightness data for the pixel, and a light emitter that outputs image data pre-stored in the memory, wherein the controller includes a data interface that transmits and receives data to and from either one or both of the memory and the light emitter.

### CROSS-REFERENCE TO RELATED APPLICATION(S)

This application claims priority from and the benefit of Korean Patent Application No. 10-2025-0015929, filed on February 7, 2025, in the Korean Intellectual Property Office, the disclosure of which is hereby incorporated by reference in its entirety for all purposes.

### BACKGROUND

### Field of the Disclosure

The present embodiments may be applied to vehicles in all fields, and more specifically, may be applied to, for example, a lamp for the vehicle.

### Description of the Related Art

In general, various sensors, electronic devices, and the like are disposed in vehicles for a convenience of a user. In particular, research on an advanced driver assistance system (ADAS) has been actively conducted for a driving convenience of the user. Furthermore, development of autonomous vehicles is being actively performed.

Conventionally, the vehicles are equipped with the various types of lamps.

For example, various lamps for the vehicle (e.g., a DRL, a position lamp, a turn signal, a brake light, an emergency light, and the like) having a lighting (e.g., a head lamp) function for easily identifying an object located around the vehicle during night travel and a signal function for notifying a travel state of the vehicle to other vehicles or road users are equipped. That is, the vehicle may be equipped with a device that operates in such a manner that light is directly emitted using a lamp, such as the head lamp that emits light forward to secure a driver's field of view, the brake light that is turned on when a brake is pressed, or the turn signal used for a right turn or a left turn.

Recently, concept vehicles designed to use such lamps for the vehicle for communication purposes have emerged.

However, to operate the existing lamps for the vehicle for the communication purposes, there is a problem in that a system becomes complicated as an image signal is generated from an image file by a graphic controller and is converted into a signal for controlling actual pixels via a complex configuration.

### SUMMARY

To solve the above-described problems, an aspect of the present disclosure is to provide a communication lamp for a vehicle and a method for controlling the same by directly using a data interface without using an image signal in operating the communication lamp.

Problems to be solved by the present disclosure are not limited to the problems mentioned above, and other problems not mentioned will be clearly understood by those skilled in the art to which the present disclosure pertains from a following description.

A communication lamp for a vehicle according to one of embodiments of the present disclosure for solving the above-described problems includes a vehicle interface that receives content data from the vehicle, a controller that analyzes the content data to generate brightness data for each pixel, a memory that stores the brightness data for the pixel, and a light emitter that outputs image data pre-stored in the memory, wherein the controller includes a data interface that transmits and receives data to and from either one or both of the memory and the light emitter.

According to an embodiment, the controller may extract the image data via packet analysis and structuring of the content data received via the vehicle interface, convert the extracted image data into the brightness data for the pixel, and perform image warping based on the converted brightness data.

According to an embodiment, the data interface may include a memory interface that transmits and receives data between the memory and the controller, and a lighting interface that transmits and receives data between the light emitter and the controller.

According to an embodiment, the controller may, when the memory interface and the lighting interface are different from each other, store the image data received from the memory in a buffer, and convert the image data stored in the buffer into a format corresponding to the lighting interface and transmit the converted image data to the light emitter.

According to an embodiment, the controller may, when the memory interface and the lighting interface are the same as each other, share the data interface and the lighting interface with the memory and the light emitter.

According to an embodiment, the controller may float the lighting interface when updating the content in the memory, and the memory may receive the image data from the controller via the memory interface.

According to an embodiment, the controller may float the memory interface when outputting the content via the light emitter, and the light emitter may receive the image data from the memory via the data interface.

According to the embodiments of the present disclosure as described above, in operating the communication lamp, the image stored in the memory is not transmitted as the image signal, but is directly received using the data interface, thereby implementing the simplified system.

Effects that may be obtained in the present disclosure are not limited to the effects mentioned above, and other effects not mentioned will be clearly understood by those skilled in the art to which the present disclosure pertains from a following description.

### BRIEF DESCRIPTION OF THE DRAWING

FIG. 1 is an overall block diagram of an autonomous driving control system to which an autonomous driving apparatus according to any one of embodiments of the present disclosure is applicable.

FIG. 2 is a diagram illustrating an example in which an autonomous driving apparatus according to any one of embodiments of the present disclosure is applied to a vehicle.

FIGS. 3 and 4 are block diagrams for illustrating a communication lamp for a vehicle according to any one of embodiments of the present disclosure.

FIG. 5 is a block diagram for illustrating an image output method of a communication lamp for a vehicle according to a first embodiment of embodiments of the present disclosure.

FIG. 6 is a block diagram for illustrating an image output method of a communication lamp for a vehicle according to a second embodiment of embodiments of the present disclosure.

FIG. 7 is a flowchart illustrating a content update operation of a communication lamp for a vehicle according to embodiments of the present disclosure.

FIG. 8 is a flowchart illustrating a camera calibration method according to embodiments of the present disclosure.

FIG. 9 is a flowchart illustrating a camera calibration method according to embodiments of the present disclosure.

### DETAILED DESCRIPTION

Hereinafter, with reference to the accompanying drawings, embodiments of the present disclosure will be described in detail so that those skilled in the art can easily practice the present disclosure. However, the present disclosure may be implemented in various different forms and is not limited to the embodiments described herein. In addition, in the drawings, in order to clearly explain the present disclosure, parts that are not related to the description will be omitted, and the same or similar parts are denoted by the same reference numerals throughout the description.

Throughout the description, when a part is referred to as “including” an element, it may not mean that the part excludes other elements, but may mean that the part includes other elements, unless stated otherwise.

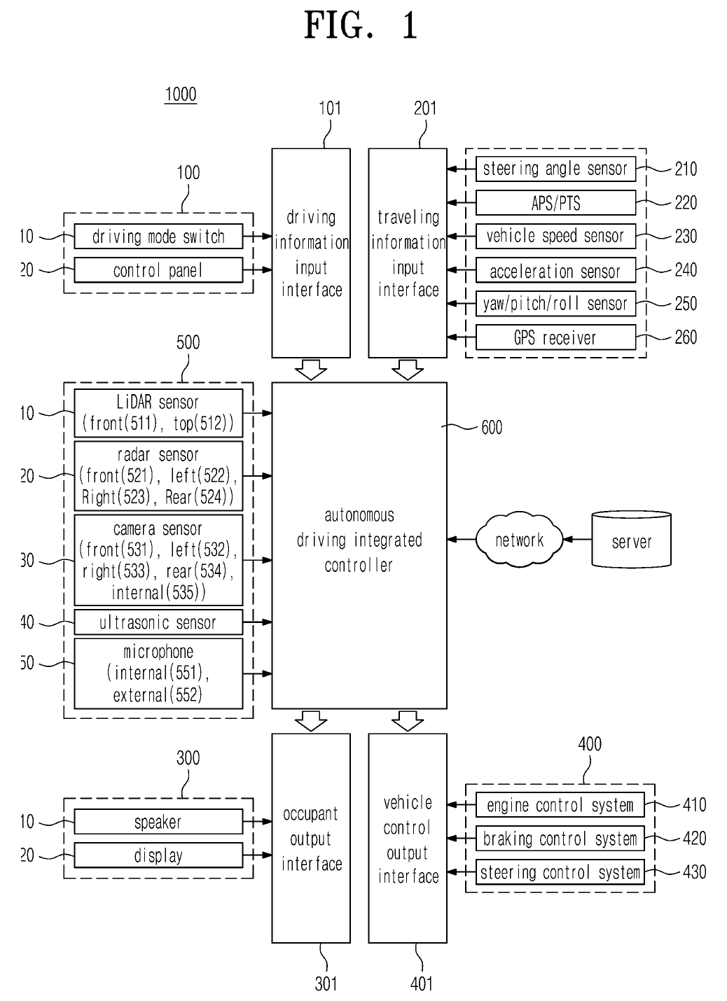

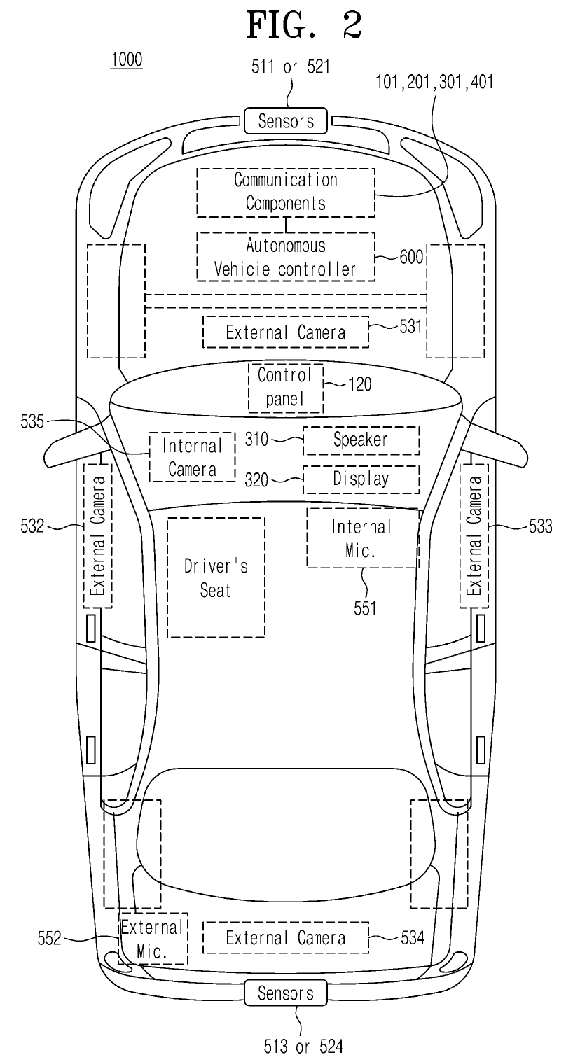

FIG. 1 is an overall block diagram of an autonomous driving control system to which an autonomous driving apparatus according to any one of embodiments of the present disclosure is applicable. FIG. 2 is a diagram illustrating an example in which an autonomous driving apparatus according to any one of embodiments of the present disclosure is applied to a vehicle.

First, a structure and function of an autonomous driving control system (e.g., an autonomous driving vehicle) to which an autonomous driving apparatus according to the present embodiments is applicable will be described with reference to FIGS. 1 and 2.

As illustrated in FIG. 1, an autonomous driving vehicle 1000 may be implemented based on an autonomous driving integrated controller 600 that transmits and receives data necessary for autonomous driving control of a vehicle through a driving information input interface 101, a traveling information input interface 201, an occupant output interface 301, and a vehicle control output interface 401. However, the autonomous driving integrated controller 600 may also be referred to herein as a controller, a processor, or, simply, a controller.

The autonomous driving integrated controller 600 may obtain, through the driving information input interface 101, driving information based on manipulation of an occupant for a user input unit 100 in an autonomous driving mode or manual driving mode of a vehicle. As illustrated in FIG. 1, the user input unit 100 may include a driving mode switch 110 and a control panel 120 (e.g., a navigation terminal mounted on the vehicle or a smartphone or tablet computer owned by the occupant). Accordingly, driving information may include driving mode information and navigation information of a vehicle.

For example, a driving mode (i.e., an autonomous driving mode/manual driving mode or a sports mode/eco mode/safety mode/normal mode) of the vehicle determined by manipulation of the occupant for the driving mode switch 110 may be transmitted to the autonomous driving integrated controller 600 through the driving information input interface 101 as the driving information.

Furthermore, navigation information, such as the destination of the occupant input through the control panel 120 and a path up to the destination (e.g., the shortest path or preference path, selected by the occupant, among candidate paths up to the destination), may be transmitted to the autonomous driving integrated controller 600 through the driving information input interface 101 as the driving information.

The control panel 120 may be implemented as a touchscreen panel that provides a user interface (UI) through which the occupant inputs or modifies information for autonomous driving control of the vehicle. In this case, the driving mode switch 110 may be implemented as touch buttons on the control panel 120.

In addition, the autonomous driving integrated controller 600 may obtain traveling information indicative of a driving state of the vehicle through the traveling information input interface 201. The traveling information may include a steering angle formed when the occupant manipulates a steering wheel, an accelerator pedal stroke or brake pedal stroke formed when the occupant depresses an accelerator pedal or brake pedal, and various types of information indicative of driving states and behaviors of the vehicle, such as a vehicle speed, acceleration, a yaw, a pitch, and a roll formed in the vehicle. The traveling information may be detected by a traveling information detection unit 200, including a steering angle sensor 210, an accelerator position sensor (APS)/pedal travel sensor (PTS) 220, a vehicle speed sensor 230, an acceleration sensor 240, and a yaw/pitch/roll sensor 250, as illustrated in FIG. 1.

Furthermore, the traveling information of the vehicle may include location information of the vehicle. The location information of the vehicle may be obtained through a global positioning system (GPS) receiver 260 applied to the vehicle. Such traveling information may be transmitted to the autonomous driving integrated controller 600 through the traveling information input interface 201 and may be used to control the driving of the vehicle in the autonomous driving mode or manual driving mode of the vehicle.

The autonomous driving integrated controller 600 may transmit driving state information provided to the occupant to an output unit 300 through the occupant output interface 301 in the autonomous driving mode or manual driving mode of the vehicle. That is, the autonomous driving integrated controller 600 transmits the driving state information of the vehicle to the output unit 300 so that the occupant may check the autonomous driving state or manual driving state of the vehicle based on the driving state information output through the output unit 300. The driving state information may include various types of information indicative of driving states of the vehicle, such as a current driving mode, transmission range, and speed of the vehicle.

If it is determined that it is necessary to warn a driver in the autonomous driving mode or manual driving mode of the vehicle along with the above driving state information, the autonomous driving integrated controller 600 transmits warning information to the output unit 300 through the occupant output interface 301 so that the output unit 300 may output a warning to the driver. In order to output such driving state information and warning information acoustically and visually, the output unit 300 may include a speaker 310 and a display 320 as illustrated in FIG. 1. In this case, the display 320 may be implemented as the same device as the control panel 120 or may be implemented as an independent device separated from the control panel 120.

Furthermore, the autonomous driving integrated controller 600 may transmit control information for driving control of the vehicle to a lower control system 400, applied to the vehicle, through the vehicle control output interface 401 in the autonomous driving mode or manual driving mode of the vehicle. As illustrated in FIG. 1, the lower control system 400 for driving control of the vehicle may include an engine control system 410, a braking control system 420, and a steering control system 430. The autonomous driving integrated controller 600 may transmit engine control information, braking control information, and steering control information, as the control information, to the respective lower control systems 410, 420, and 430 through the vehicle control output interface 401. Accordingly, the engine control system 410 may control the speed and acceleration of the vehicle by increasing or decreasing fuel supplied to an engine. The braking control system 420 may control the braking of the vehicle by controlling braking power of the vehicle. The steering control system 430 may control the steering of the vehicle through a steering device (e.g., motor driven power steering (MDPS) system) applied to the vehicle.

As described above, the autonomous driving integrated controller 600 according to the present embodiment may obtain the driving information based on manipulation of the driver and the traveling information indicative of the driving state of the vehicle through the driving information input interface 101 and the traveling information input interface 201, respectively, and transmit the driving state information and the warning information, generated based on an autonomous driving algorithm, to the output unit 300 through the occupant output interface 301. In addition, the autonomous driving integrated controller 600 may transmit the control information generated based on the autonomous driving algorithm to the lower control system 400 through the vehicle control output interface 401 so that driving control of the vehicle is performed.

In order to guarantee stable autonomous driving of the vehicle, it is necessary to continuously monitor the driving state of the vehicle by accurately measuring a driving environment of the vehicle and to control driving based on the measured driving environment. To this end, as illustrated in FIG. 1, the autonomous driving apparatus according to the present embodiment may include a sensor unit 500 for detecting a nearby object of the vehicle, such as a nearby vehicle, pedestrian, road, or fixed facility (e.g., a signal light, a signpost, a traffic sign, or a construction fence).

The sensor unit 500 may include one or more of a LiDAR sensor 510, a radar sensor 520, or a camera sensor 530, in order to detect a nearby object outside the vehicle, as illustrated in FIG. 1.

The LiDAR sensor 510 may transmit a laser signal to the periphery of the vehicle and detect a nearby object outside the vehicle by receiving a signal reflected and returning from a corresponding object. The LiDAR sensor 510 may detect a nearby object located within the ranges of a preset distance, a preset vertical field of view, and a preset horizontal field of view, which are predefined depending on specifications thereof. The LiDAR sensor 510 may include a front LiDAR sensor 511, a top LiDAR sensor 512, and a rear LiDAR sensor 513 installed at the front, top, and rear of the vehicle, respectively, but the installation location of each LiDAR sensor and the number of LiDAR sensors installed are not limited to a specific embodiment. A threshold for determining the validity of a laser signal reflected and returning from a corresponding object may be previously stored in a memory (not illustrated) of the autonomous driving integrated controller 600. The autonomous driving integrated controller 600 may determine a location (including a distance to a corresponding object), speed, and moving direction of the corresponding object using a method of measuring time taken for a laser signal, transmitted through the LiDAR sensor 510, to be reflected and returning from the corresponding object.

The radar sensor 520 may radiate electromagnetic waves around the vehicle and detect a nearby object outside the vehicle by receiving a signal reflected and returning from a corresponding object. The radar sensor 520 may detect a nearby object within the ranges of a preset distance, a preset vertical field of view, and a preset horizontal field of view, which are predefined depending on specifications thereof. The radar sensor 520 may include a front radar sensor 521, a left radar sensor 522, a right radar sensor 523, and a rear radar sensor 524 installed at the front, left, right, and rear of the vehicle, respectively, but the installation location of each radar sensor and the number of radar sensors installed are not limited to a specific embodiment. The autonomous driving integrated controller 600 may determine a location (including a distance to a corresponding object), speed, and moving direction of the corresponding object using a method of analyzing power of electromagnetic waves transmitted and received through the radar sensor 520.

The camera sensor 530 may detect a nearby object outside the vehicle by photographing the periphery of the vehicle and detect a nearby object within the ranges of a preset distance, a preset vertical field of view, and a preset horizontal field of view, which are predefined depending on specifications thereof.

The camera sensor 530 may include a front camera sensor 531, a left camera sensor 532, a right camera sensor 533, and a rear camera sensor 534 installed at the front, left, right, and rear of the vehicle, respectively, but the installation location of each camera sensor and the number of camera sensors installed are not limited to a specific embodiment. The autonomous driving integrated controller 600 may determine a location (including a distance to a corresponding object), speed, and moving direction of the corresponding object by applying predefined image processing to an image captured by the camera sensor 530.

In addition, an internal camera sensor 535 for capturing the inside of the vehicle may be mounted at a predetermined location (e.g., rear view mirror) within the vehicle. The autonomous driving integrated controller 600 may monitor a behavior and state of the occupant based on an image captured by the internal camera sensor 535 and output guidance or a warning to the occupant through the output unit 300.

As illustrated in FIG. 1, the sensor unit 500 may further include an ultrasonic sensor 540 in addition to the LiDAR sensor 510, the radar sensor 520, and the camera sensor 530 and further adopt various types of sensors for detecting a nearby object of the vehicle along with the sensors.

FIG. 2 illustrates an example in which, in order to aid in understanding the present embodiment, the front LiDAR sensor 511 or the front radar sensor 521 is installed at the front of the vehicle, the rear LiDAR sensor 513 or the rear radar sensor 524 is installed at the rear of the vehicle, and the front camera sensor 531, the left camera sensor 532, the right camera sensor 533, and the rear camera sensor 534 are installed at the front, left, right, and rear of the vehicle, respectively. However, as described above, the installation location of each sensor and the number of sensors installed are not limited to a specific embodiment.

Furthermore, in order to determine a state of the occupant within the vehicle, the sensor unit 500 may further include a bio sensor for detecting bio signals (e.g., heart rate, electrocardiogram, respiration, blood pressure, body temperature, electroencephalogram, photoplethysmography (or pulse wave), and blood sugar) of the occupant. The bio sensor may include a heart rate sensor, an electrocardiogram sensor, a respiration sensor, a blood pressure sensor, a body temperature sensor, an electroencephalogram sensor, a photoplethysmography sensor, and a blood sugar sensor.

Finally, the sensor unit 500 additionally includes a microphone 550 having an internal microphone 551 and an external microphone 552 used for different purposes.

The internal microphone 551 may be used, for example, to analyze the voice of the occupant in the autonomous driving vehicle 1000 based on AI or to immediately respond to a direct voice command of the occupant.

In contrast, the external microphone 552 may be used, for example, to appropriately respond to safe driving by analyzing various sounds generated from the outside of the autonomous driving vehicle 1000 using various analysis tools such as deep learning.

For reference, the symbols illustrated in FIG. 2 may perform the same or similar functions as those illustrated in FIG. 1. FIG. 2 illustrates in more detail a relative positional relationship of each component (based on the interior of the autonomous driving vehicle 1000) as compared with FIG. 1.

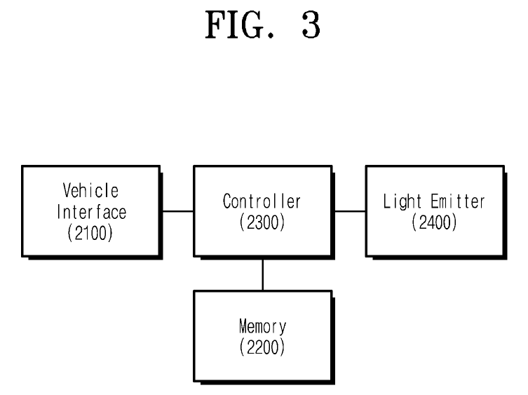

FIGS. 3 and 4 are block diagrams for illustrating a communication lamp for a vehicle according to any one of embodiments of the present disclosure.

Referring to FIGS. 3 and 4, a communication lamp 2000 for a vehicle may include a vehicle interface 2100, a memory 2200, a controller 2300, and a light emitter 2400.

The vehicle interface 2100 may transmit a control signal and update content transmitted to the vehicle. The vehicle interface 2100 may include a low-voltage differential signal (LVDS) driver & receiver, a CAN transceiver, and the like.

The LVDS driver & receiver refers to a high-speed long-distance digital interface for serial communication via two copper wires spaced apart from each other. In this regard, it may be composed of five pairs of differential lines, and to synchronize the five pairs of data lines, lengths of cables may need to be kept as equal as possible.

The controller area network (CAN) transceiver may be a communication transceiver for communication between the vehicle and a network.

The vehicle interface 2100 may receive content data from the vehicle.

The memory 2200, as a kind of storage medium in which various information or programs are stored, may store an image. The image includes a video or a photograph.

The memory 2200 may store data for content output by the light emitter 2400. The memory 2200 may include a first memory that stores the data for the content. The first memory may be equipped as a NAND memory, an eMMC memory, or the like.

The memory 2200 may store data for firmware output by the light emitter 2400. The memory 2200 may include a second memory that stores the data for the firmware. The second memory may be equipped as an NOR memory.

The controller 2300 may include an internal memory. The internal memory may include a buffer 2320.

The controller 2300 may include a data interface that transmits and receives data to and from at least one of the memory 2200 and the light emitter 2400 for pixel control. Specifically, the data interface may be a large-capacity data interface.

The controller 2300 may perform overall control such as providing data to the light emitter 2400 based on the input image.

The controller 2300 may directly control a high-resolution pixel-level lighting device with a high-capacity data signal without transmitting the image stored in the memory 2210 for the content as an image signal.

The controller 2300 may analyze the content data received via the vehicle interface 2100 and generate brightness data for each pixel. For example, the controller 2300 may convert an image in the content into the brightness data for controlling each pixel.

Specifically, the controller 2300 may extract image data via packet analysis and structuring of the content data received via the vehicle interface 2200. The controller 2300 may convert the extracted image data into the brightness data for the pixel.

In one example, the controller 2300 may analyze the content data received via the vehicle interface 2100 to generate warped image data. Specifically, the controller 2300 may perform image warping based on the converted brightness data.

In one example, the data interface may include a memory interface that transmits and receives data between the memory 2200 and the controller 2300 and a lighting interface that transmits and receives data between the light emitter 2400 and the controller 2300.

Accordingly, when the memory interface is different from the lighting interface, the controller 2300 may store the image data received from the memory 2200 in the buffer. The controller 2300 may convert the image data stored in the buffer into a format corresponding to the lighting interface and transmit the converted image data to the light emitter.

On the other hand, when the memory interface is the same as the lighting interface, the controller 2300 may share the data interface and the lighting interface with the memory 2200 and the light emitter 2400.

For example, when updating the content in the memory 2200, the controller 2300 may float the lighting interface. Accordingly, the memory 2400 may receive the image data from the controller 2300 via the memory interface.

For example, when outputting the content via the light emitter 2400, the controller 2300 may float the memory interface. The light emitter 2400 may receive the image data from the memory via the data interface.

The light emitter 2400 may include a pixel-level lighting device capable of outputting the image. The light emitter 2400 may correspond to a high-resolution pixel-level lighting device such as a DMD or an HD Micro LED.

The light emitter 2400 may output the image data pre-stored in the memory 2200.

FIG. 4 is a block diagram for illustrating a content update operation of a communication lamp for a vehicle according to any one of embodiments of the present disclosure.

Referring to FIG. 4, the controller 2300 may receive an update image via the vehicle interface 2100. The controller 2300 may transmit the update image to the NAND memory 2210 in the memory 2200 via the internal memory 3000.

To this end, the controller 2300 may perform parsing of performing packet analysis and structuring of the received update image data.

The controller 2300 may extract each data from the parsed data via a buffer 3100. Specifically, the controller 2300 may extract values of RED data, GREEN data, and BLUE data via an RGB buffer.

The controller 2300 may convert each extracted RGB value into the brightness data for the pixel via an LED pixel buffer.

The controller 2300 may transmit the data in units of LED resolution. In this regard, the controller 2300 may divide data collected in the buffers 3100 and 3200 into packets of a predetermined size and transmit the packets.

The controller 2300 may perform the image warping and store the warped image in the NAND memory, which is the memory 2210 for the content. An image warping method may be a method of correcting image distortion by designating four vertices of the image, calculating a transformation matrix, and then rearranging the four corner points of the image using the corresponding matrix.

The image warping may be performed before the data is stored in the memory 2200. For example, the image warping may be performed after the image data extraction, and the warped image data may then be converted into the brightness data.

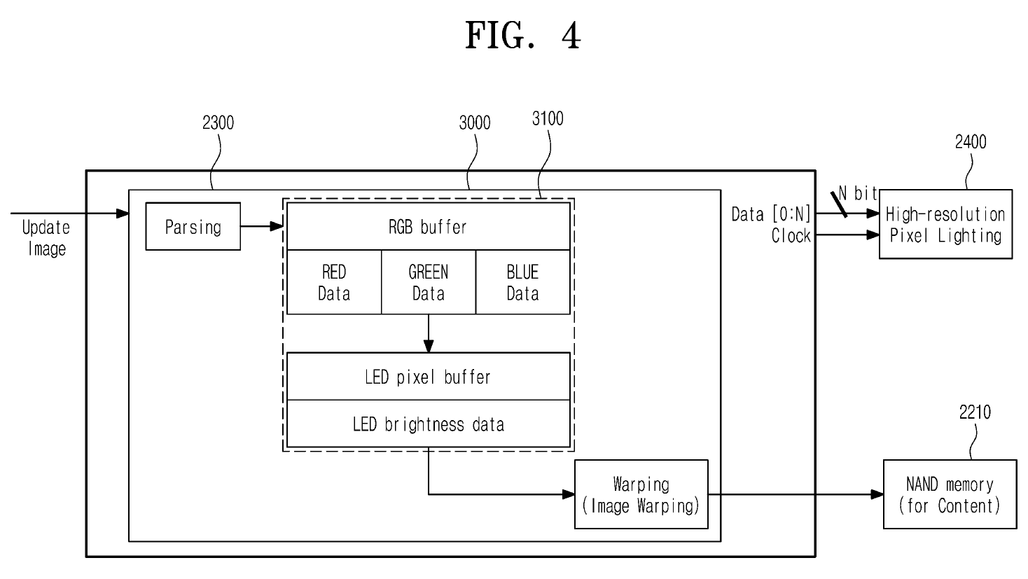

FIG. 5 is a block diagram for illustrating an image output method of a communication lamp for a vehicle according to a first embodiment of embodiments of the present disclosure.

Referring to FIG. 5, illustrated is a case in which the lighting interface connecting the light emitter 2400 with the controller 2300 and the memory interface connecting the memory 2200 with the controller 2300 are different from each other when the communication lamp 2000 for the vehicle outputs a large-capacity image.

The controller 2300 may receive the large-capacity image stored in the memory 2200 via the memory interface 4100. The large-capacity image received by the controller 2300 may be transmitted to the light emitter 2400 via the lighting interface 4200 of the high-resolution pixel-level lighting device after passing the buffer 3100. For example, the memory interface 4100 may be an interface for transmitting the content.

In this regard, when the memory interface 4100 connected to the controller 2300 and the interface 4200 of the high-resolution pixel-level lighting device 2400 are different interfaces, the controller 2300 may change the format of the data via the buffer 3100 and transmit the changed data to the light emitter 2400.

Specifically, when the memory 2210 for the content in the memory 2200 is an eMMC memory, the memory 2200 may transmit and receive the data to and from the controller 2300 via the memory interface 4100 connected to the eMMC memory. In this regard, the memory interface 4100 may transmit and receive n bit data.

When the memory for the content in the light emitter 2400 is the NAND memory, the memory 2200 may transmit and receive the data to and from the controller 2300 via the NAND memory interface 4100. In this regard, the NAND memory interface 4100 may transmit and receive N bit data.

The controller 2300 may receive n bit image data, and transmit N bit data and clock data to the light emitter 2400 via the buffer 3100.

In this regard, the large-capacity data interface 2310 may operate in a double data rate (DDR) method to increase a transmission speed. In addition, the large-capacity data interface 2310 may operate in a low voltage complementary metal oxide semiconductor (LVCMOS) interface method capable of increasing the transmission speed by swinging data with a low voltage.

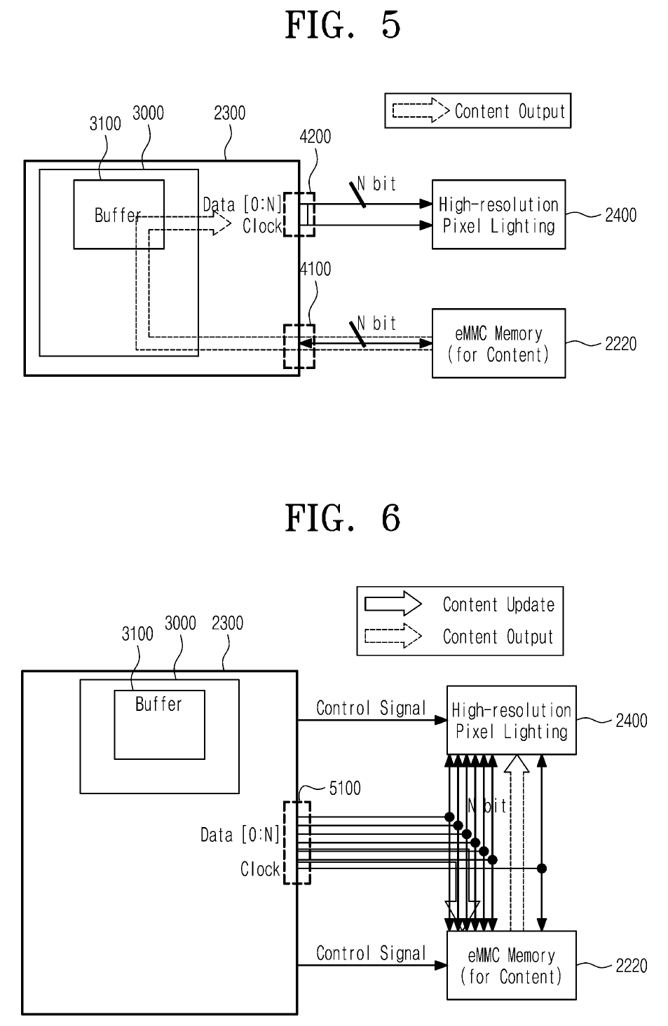

FIG. 6 is a block diagram for illustrating an image output method of a communication lamp for a vehicle according to a second embodiment of embodiments of the present disclosure.

Referring to FIG. 6, illustrated is a case in which the lighting interface connecting the light emitter 2400 with the controller 2300 and the memory interface connecting the memory 2200 with the controller 2300 are the same when the communication lamp 2000 for the vehicle outputs the large-capacity image.

When the memory interface between the controller 2300 and the memory 2200 and the interface of the high-resolution pixel-level lighting device between the controller 2300 and the light emitter 2400 are the same, the controller 2300 may share a data interface 5100 with the light emitter 2400 and the memory 2200.

Accordingly, the light emitter 2400 may directly access the memory 2200 to transmit and receive data.

In this regard, the remaining one excluding the two in communication with each other among the memory 2200, the controller 2300, and the light emitter 2400 may float an interface line to prevent a communication collision.

Specifically, when content is updated, the controller 2300 may transmit a control signal for the content update to the memory 2200 and the light emitter 2400. Accordingly, a lighting interface line connecting the memory 2200 with the light emitter 2400 may be floated. Accordingly, the controller 2300 may transmit the N bit data and the clock data of the memory 2200 to the light emitter 2400.

In one example, when the content is output, the controller 2300 may transmit a content output control signal to the memory 2200 and the light emitter 2400. Accordingly, a memory interface line connecting the memory 2200 with the controller 2300 may be floated. Accordingly, the N bit data may be directly transmitted from the memory 2200 to the light emitter 2400.

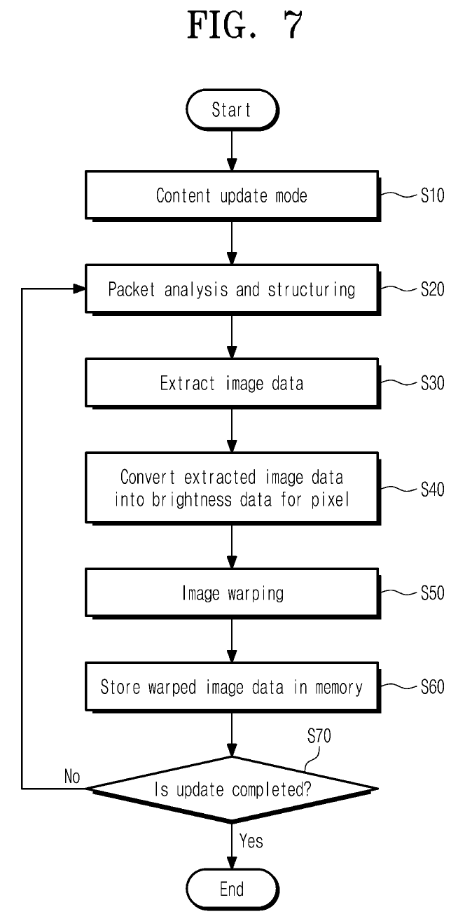

FIG. 7 is a flowchart illustrating a content update operation of a communication lamp for a vehicle according to embodiments of the present disclosure.

Referring to FIG. 7, when the communication lamp 2000 for the vehicle operates in a content update mode (S10), the parsing of performing the packet analysis and structuring of the content data received from the vehicle may be performed (S20).

After step S20, the communication lamp 2000 for the vehicle may extract the image data from the parsed data via the buffer 3100 (S30).

After step S30, the communication lamp 2000 for the vehicle may convert the extracted image data into the brightness data for the pixel (S40).

After step S40, the communication lamp 2000 for the vehicle may perform the image warping based on the image data (S50). The image warping method may be the method of correcting the image distortion by designating the four vertices of the image, calculating the transformation matrix, and then rearranging the four corner points of the image using the corresponding matrix.

After step S50, the communication lamp 2000 for the vehicle may store the warped image data and the brightness data in the memory (S60).

After step S60, the communication lamp 2000 for the vehicle may determine whether the content update is completed (S70). When the content update is not completed, the communication lamp 2000 for the vehicle may again perform the parsing of performing the packet analysis and structuring.

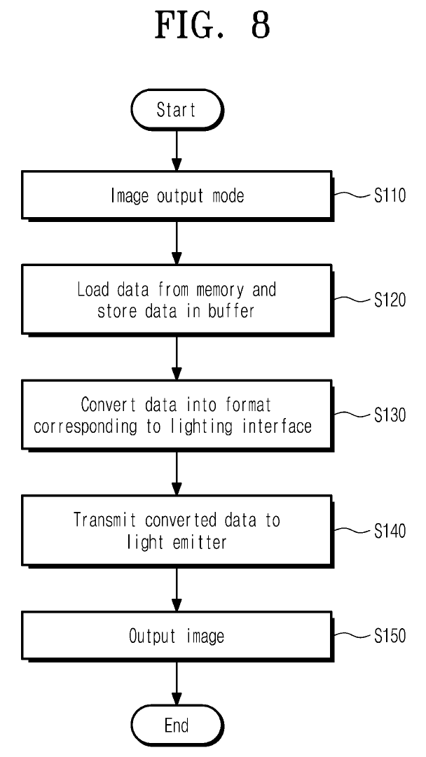

FIG. 8 is a flowchart illustrating a camera calibration method according to embodiments of the present disclosure.

Referring to FIG. 8, the communication lamp 2000 for the vehicle may operate in an image output mode when the lighting interface connecting the light emitter 2400 with the controller 2300 and the memory interface connecting the memory 2200 with the controller 2300 are different from each other (S110).

After step S110, the communication lamp 2000 for the vehicle may load the image data stored in the memory 2200 and store the image data in the buffer in the controller 2400 (S120).

After step S110, the communication lamp 2000 for the vehicle may convert the data into the format corresponding to the lighting interface via the buffer 3100 (S130).

After step S130, the communication lamp 2000 for the vehicle may transmit the converted data to the light emitter 2400 (S140).

After step S140, the communication lamp 2000 for the vehicle may output the image corresponding to the converted data via the light emitter 2400 (S150).

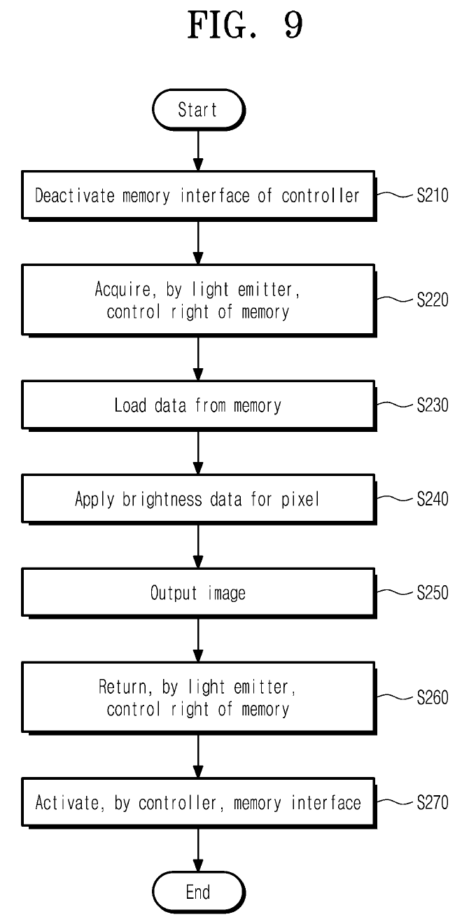

FIG. 9 is a flowchart illustrating a camera calibration method according to embodiments of the present disclosure.

Referring to FIG. 9, when the lighting interface connecting the light emitter 2400 with the controller 2300 and the memory interface connecting the memory 2200 with the controller 2300 are the same as each other and the image is output, the communication lamp 2000 for the vehicle may deactivate the memory interface of the controller 2300 (S210).

After step S210, in the communication lamp 2000 for the vehicle, the light emitter 2400 may acquire a control right of the memory 2200 (S220). To this end, the communication lamp 2000 for the vehicle may provide a control signal to the memory 2200 and the light emitter 2400 via the controller 2300.

After step S220, the controller 2300 of the communication lamp 2000 for the vehicle may load the image data from the memory 2200 (S230).

After step S230, the communication lamp 2000 for the vehicle may apply the brightness data for the pixel to the image data via the controller 2300 (S240).

After step S240, the communication lamp 2000 for the vehicle may output the image corresponding to the image data via the light emitter 2400 (S250).

After step S250, the light emitter 2400 of the communication lamp 2000 for the vehicle may return the control right of the memory 2200 (S260).

After step S260, the controller 2300 of the communication lamp 2000 for the vehicle may activate the memory interface (S270).

That is, the technical idea of the present disclosure may be applied to an entirety of the autonomous vehicle or may be applied only to some components inside the autonomous vehicle. The scope of the present disclosure should be determined based on the matters described in the claims.

As another aspect of the present disclosure, the above-described proposal or operation of the present disclosure may be provided with a code that may be realized, implemented, or executed by a "computer" (a comprehensive concept including a system on chip (SoC), a microprocessor, or the like) or an application, a computer-readable storage medium, a computer program product, or the like that stores or contains the code, and also falls within the scope of the present disclosure.

A detailed description of the preferred embodiments of the present disclosure disclosed as described above has been provided to those skilled in the art to realize and implement the present disclosure. Although the description has been made with reference to the preferred embodiments of the present disclosure, those skilled in the art will understand that the present disclosure may be variously modified and changed without departing from the scope of the present disclosure. For example, those skilled in the art may use each of the components described in the above-described embodiments in a manner of combining them with each other.

Therefore, the present disclosure is not intended to be limited to the embodiments described herein, but is to be accorded the broadest scope consistent with the principles and novel features disclosed herein.

What is claimed is:

1. A communication lamp for a vehicle, comprising:
a vehicle interface configured to receive content data from the vehicle;
a controller configured to analyze the content data to generate brightness data for each pixel;
a memory configured to store the brightness data for the pixel; and
a light emitter configured to output image data pre-stored in the memory,
wherein the controller includes a data interface configured to transmit and receive data to and from either one or both of the memory and the light emitter.

2. The communication lamp of claim 1, wherein the controller is further configured to:
extract the image data via packet analysis and structuring of the content data received via the vehicle interface;
convert the extracted image data into the brightness data for the pixel; and
perform image warping based on the converted brightness data.

3. The communication lamp of claim 2, wherein the data interface includes:
a memory interface configured to transmit and receive data between the memory and the controller; and
a lighting interface configured to transmit and receive data between the light emitter and the controller.

4. The communication lamp of claim 3, wherein the controller is further configured to:
when the memory interface and the lighting interface are different from each other,
store the image data received from the memory in a buffer; and
convert the image data stored in the buffer into a format corresponding to the lighting interface and transmit the converted image data to the light emitter.

5. The communication lamp of claim 3, wherein the controller is further configured to:
when the memory interface and the lighting interface are the same as each other,
share the data interface and the lighting interface with the memory and the light emitter.

6. The communication lamp of claim 5, wherein the controller is further configured to float the lighting interface when updating the content in the memory, and
wherein the memory is configured to receive the image data from the controller via the memory interface.

7. The communication lamp of claim 5, wherein the controller is further configured to float the memory interface when outputting the content via the light emitter, and
wherein the light emitter is configured to receive the image data from the memory via the data interface.

8. A method for controlling a communication lamp for a vehicle, the method comprising:
receiving content data from the vehicle;
analyzing the content data to generate brightness data for each pixel;
storing the brightness data for the pixel; and
outputting pre-stored image data.

9. The method of claim 8, wherein the analyzing of the content data includes:
extracting the image data via packet analysis and structuring of the received content data;
converting the extracted image data into the brightness data for the pixel; and
performing image warping based on the converted brightness data.

10. The method of claim 8, wherein the outputting of the pre-stored image data includes:
storing the image data received from a memory in a buffer; and
converting the image data stored in the buffer into a format corresponding to a data interface and transmitting the converted image data to a light emitter.

11. A vehicle-mounted communication lighting system comprising:
a vehicle interface configured to receive content data from a vehicle;
a controller configured to analyze the content data by performing packet analysis and structuring to obtain image data, to convert the image data into brightness data, and to perform image warping on the brightness data;
a memory in communication with the controller and configured to store the brightness data including the warped image data;
a light emitter comprising a pixel-level lighting device configured to output an image based on the brightness data stored in the memory; and
a data interface shared by the memory, the controller, and the light emitter,
wherein the controller is configured to selectively float either a memory interface or a lighting interface to prevent communication collision when updating the memory or when outputting the image.

12. The system of claim 11, wherein the controller is further configured to perform the image warping by using a transformation matrix determined according to a camera-based calibration method, so that the image output by the light emitter is corrected for distortion relative to a predetermined region on the vehicle.
